(19) United States
(12) Patent Application Publication
(10) Pub. No.: US 2006/0127198 A1
(43) Pub. Date: Jun. 15, 2006

(54) Liquor container for a washing machine

(75) Inventor: Ismael Gracia Bobed, Zaragoza (ES)

Correspondence Address: Craig J Loest;Bsh Home Appliances Corporation, 100 Bosch Boulevard, New Bern, NC, 28562, US

(73) Assignee: BSH Bosch und Siemens Hausgerate GmbH, Munich (DE)

(21) Appl. No.: 10/527,536

(22) PCT Filed: Aug. 28, 2003
(86) PCT No.: PCT/EP03/09638

§ 371 Date: Oct. 3, 2005

(30) Foreign Application Priority Data
Sep. 11, 2002 (ES) P200202160

(51) Int. Cl. F16B 13/04

(52) U.S. Cl. 411/41; 411/46; 411/15

(57) ABSTRACT

A washing machine lye container comprising two halves which have connecting means on the mouth 1, 2 of their open base section to execute the fixing of the two one to the other; one of the mouths 1 of the two halves comprises a plurality of radial extensions 3, 3a with an opening 4, 4a which has two sections 5, 5a, 6, 6a in whose connecting region it has a smaller diameter 15, 18. The mouth 2 of the other half has a plurality of pins 8 with an axial through hole 10 in whose rear access dowels 13 are contained in the through hole 10. In addition, the pins comprise slots 9 so that the walls can be tapered to a smaller diameter when the pin 8 is inserted into the opening 4, 4a of the radial extension 3, 3a and for spreading when the dowel 13 is driven into the through hole 10 of the pin 8.

### OBJECT OF THE INVENTION

The invention relates to a washing machine lye container of the type which is formed by two halves which are connected by the mouths of their open base sections and which can be separated to allow repair of any defects which may arise.

It is the object of the invention to make it possible to fix both halves in a fast and simple fashion which should also be fixed and permanent.

It is a further object of the invention to make it possible to separate both halves in a fast and simple fashion without the need for any disturbance of the connecting elements in order that any repairs of defects can be carried out and the two halves can then be connected after carrying out the repair.

### GENERAL PRIOR ART

Known in the prior art are washing machine lye containers having a laundry drum accommodated in their interior. These lye containers are formed by two halves of open base sections which are produced by injection moulding and whose mouths comprise additional fixing means to fix the two halves by interposing a seal.

Such a washing machine lye container is known from the Spanish patent 96 00 222 which was granted to the proprietor of the present invention and describes additional fixing means of the two halves. In one of the halves, axial projections in harpoon-tip form are formed for this purpose in the mouth of its open base section, which projections are guided into radial attachments in inverse U-shape and held fixedly therein, which are provided in the mouth of the open base section of the other half.

This arrangement makes it possible to connect the two halves by means of a simple pressure thrust and subsequent separation of the same using a screw driver or the like by releasing the axial harpoon-tip projections from the U-shaped attachments, whereby repairs can be carried out in the event of defects.

After carrying out a repair, the two halves can be joined together again for which a plurality of conventional lugs are provided at their mouths which make a connection possible using corresponding screws and nuts.

### DESCRIPTION OF THE INVENTION

The invention succeeds in eliminating the disadvantages of the prior art in which expensive lugs are required to connect the mouths of the two halves of the lye container in order to re-assemble the two halves after a separation, by additional connecting means at the mouth of one of the two halves having a plurality of radial extensions which are provided with an opening, which is formed by a front section and a rear section and has a smaller diameter in their connection region.

In addition, the mouth of the other half comprises a plurality of pins having a diameter larger than the smaller diameter of the opening of the radial extension. The pins are provided with an axial opening in whose rear access dowels are contained in the axial through hole. The pins are additionally provided with longitudinal grooves so that, to bring about the joining of the two halves forming the cylinder, the pins are guided into the corresponding opening of the radial extension during which displacement the walls of the pins close as a result of the arrangement of the longitudinal grooves and because the diameter of the pins is greater than the diameter of the opening provided in the radial extensions. When the pins have penetrated through the openings, the dowels are pressed into the axial through hole. This process brings with it the fact that the pin wall is opened by pressing against the walls of the front section of the opening of the radial extensions whereby a fixed and permanent fixing is achieved.

In one embodiment of the invention, the rear section of the opening of the radial extensions has a diameter which increases from the inside to the outside to make it possible to open the wall of the pin.

In the preferred embodiment of the invention, the rear section of the opening of the radial extensions is truncated-cone-shaped.

In the same way, the front section of the opening of the radial extensions has a diameter which decreases from the inside to the outside, such as a truncated-cone-shaped section for example, to make it possible to introduce the pins, these having a diameter smaller than the access to the front section of the opening.

In another embodiment of the invention, in the transition region from the front and rear sections of the opening a gradation is provided in which case the front end of the pins is terminated by locating hooks for coupling into the gradation and thereafter in order to achieve the correct fixing the dowels are inserted into the axial through hole in order to press the dowels through said opening whereby it is achieved that the walls of the pins open whereby the locating hooks are coupled in without the possibility of release again.

In each of the two embodiments described it is provided that the opening of the radial extension comprises pin insertion stops which are preferably arranged on the front edge of the rear section.

In order to be able to retain the dowel in the axial through hole of the pin, small fixing ribs are provided on the front access of the axial through hole.

The dowel is retained with the aid of the small fixing ribs on one section in the axial through hole of the pin having a truncated-cone-shaped access whose larger diameter forms the access to the radial through hole.

In the preferred embodiment of the invention the dowel in the axial through hole of the pin is formed by a cylindrical body whose end used for insertion is provided with a run-in slope on the circumference which facilitates the insertion into the through hole.

All the embodiments of the invention described make it possible to dismantle the two halves forming the lye container in order to carry out repairs, for example, if these are necessary. For this purpose, the cylindrical dowel is first removed (using a tool) so that its wall returns to the rest position whereby the removal of the pin from the interior of the opening of the radial extensions is made possible. For the case where the pins are located by the locating hooks, these must be unlocked using a tool in order to bring about the complete release and uncoupling of the same whereby it is possibly to remove the pins.

For joining together again, the halves can be connected again by inserting the pins again into the corresponding opening and instead of the dowel, inserting a screw from the free end of the pin through the opening of the radial extension and the through hole of the pin and tightening, whereby the wall of the pin spreads and the joining of the two halves one to the other is thereby brought about.

It should be noted that in the embodiments described a concentric protective projection for the dowel can be provided on the rear side of the pin to facilitate the dismantling of the lye container.

### BRIEF DESCRIPTION OF THE FIGURES

Several exemplary embodiments of the invention are shown in the drawings which will be described in detail below. In the figures

FIG. 1 is a perspective view of a pin which is arranged on the mouth of an open base section of one of the two halves of the lye container and is arranged towards the opening of the allocated radial extension which is attached to the mouth of the open base section of the other half,

FIG. 2 is a perspective view from the back side of the pin according to FIG. 1,

FIG. 3 is a cross-section through a pin and an opening according to FIG. 1, showing the internal structure of each of the elements contained therein,

FIG. 4 is a view of the pin and the opening according to FIG. 3 in which the two lye container halves are connected by means of the dowel in the pin as a result of the spreading inside the opening of the radial extension,

FIG. 5 shows a connection of the lye container halves according to FIG. 4 which were reconstructed after dismantling, wherein a screw in the interior of the axial through hole of the pin replaces the dowel,

FIG. 6 shows a cross-section through a pin and an opening according to another embodiment of the invention in an assembly phase according to FIG. 3 and

FIG. 7 shows a cross-section through an embodiment according to FIG. 6 in the assembled state.

### DESCRIPTION OF THE PREFERRED EMBODIMENTS

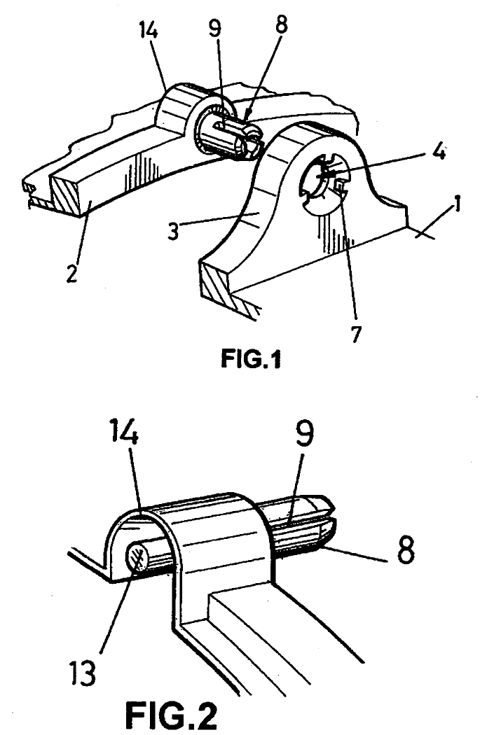

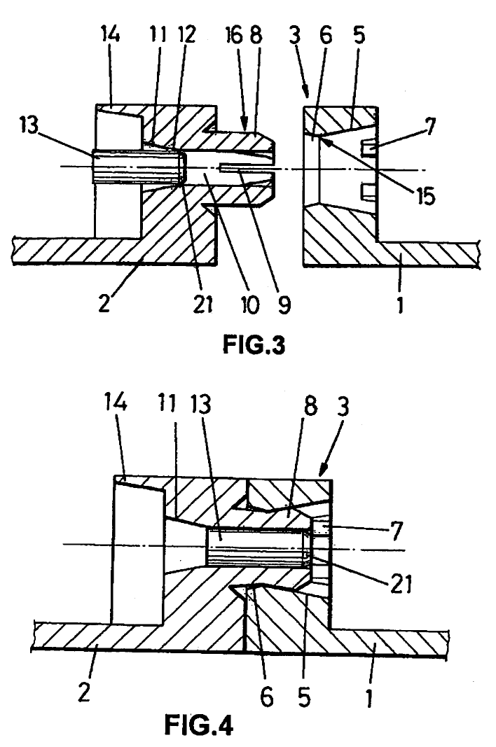

FIGS. 1 to 5 show a first exemplary embodiment in which a washing machine lye container (not shown) having a laundry drum (not shown) mounted in its interior, is formed by two halves which are connected by the mouths 1 and 2 of their open base sections by interposing a seal, which is not shown in the drawing.

For this purpose one of the mouths 1 has a plurality of radial extensions 3 (for simplicity only one is shown) provided with an opening 4 which is formed by two truncated-cone-shaped sections 5 and 6 wherein the front section 5 and also the rear section 6 decreases from outside to inside whereby they define a smaller diameter 15 in the area in which they combine.

In addition, the other mouth 2 of the open base section of the other half of the drum comprises a plurality of pins 8 which are arranged in accordance with the openings 4.

The pins are provided with slots 9 which are offset in relation to stops 7 arranged on the front section 5 of the opening 4.

In addition, the pins 8 contain an axial through hole 10 which has a truncated-cone-shaped section 11 in its rear mouth, which accommodates a cylindrical member, a dowel 13, which is retained in the access of the through hole 10 with the aid of small ribs 12.

In addition, the rear end of the pin 8 is provided with a concentric protective projection 14 for the dowel 13 which protects the dowel when the halves of the lye container are transported.

At this point it should be noted that the outside diameter of the pin 8 is larger than the smaller diameter 15 at which the two sections 5 and 6 combine.

For making the connection between the two halves of the lye container, the pins 8 are arranged opposite to the openings 4 for insertion. Insertion is facilitated by a slope which is provided on the front end of the pin 8 and makes possible its entry into the rear section 6 of the opening 4 whereafter, since this section tapers to the smaller diameter 15, the walls of the pin 8 becomes narrower during its insertion as a result of the slot 9 until the end of the pin 8 contacts the stops 7.

The dowel 13 is then inserted into the axial through hole. This process takes place as a result of a single pressure thrust which breaks the small ribs 12 and presses in the dowel 13 which, during its insertion, exerts force to open the walls of the pin 8, pressing this towards the front section 5 of the through hole 4 (FIG. 4) so that a perfect connection of the two lye container halves one with the other is achieved.

The dowel 13 has a circumferential run-in slope 21 at its front end which facilitates its insertion into the through hole 10 under pressure.

After making the connection, these two halves can also be separated again. For this purpose, the dowel 13 is removed, by pressing it outwards from the front or rear side of the through hole 10 with the aid of a tool so that on removal of the dowel 13, it is possible for the pin 8 to be removed from the opening whereby the two halves of the lye container can be separated.

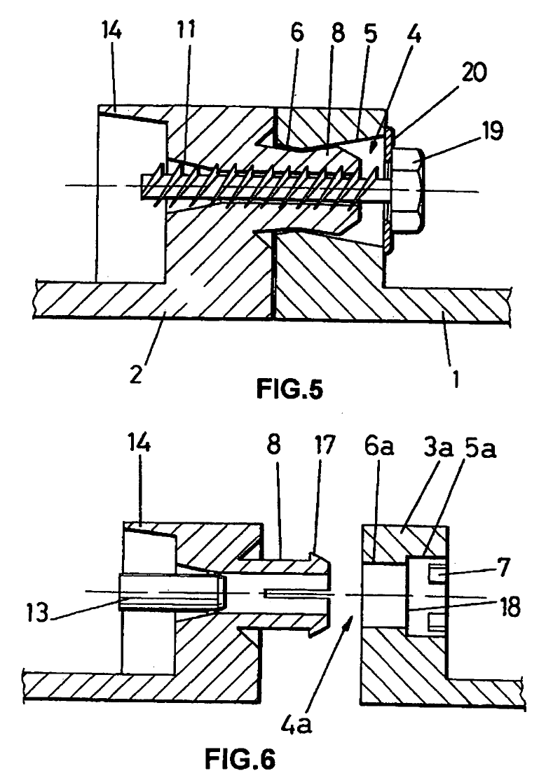

For assembly the procedure already described is followed. During repeated assembly of the fixing the dowel 13 can be used again. However, since it is made of plastic it could possibly have lost some diameter and then could no longer sufficiently secure the connection. However, in order to ensure that the connection is sufficiently stable after re-assembly, a new dowel having a larger diameter can be used. Instead of the fixing using a dowel 13, the fixing can also be executed using a self-tapping screw 19 by arranging a washer 20 on the access of the opening 4 (FIG. 5).

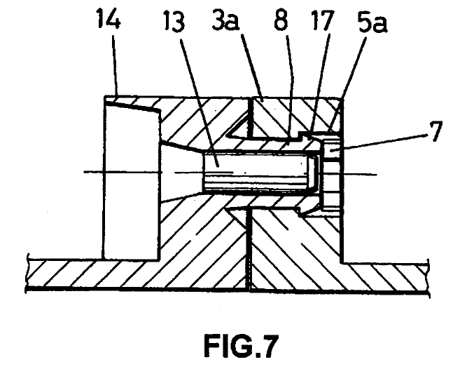

FIGS. 6 and 7 show another possible exemplary embodiment of the invention in which the pins 8 end in locating hooks 17 at their front end. In this case, the opening 4a has a cylindrical front section 5a which continues after a gradation 18 in accordance with a rear section 6a. The gradation 18 defines a diameter which corresponds to the diameter 15.

To make the connection between the two halves of the lye container, the pins are inserted into the interior of the opening 4a. During the insertion process the walls of the pin 8 close as a result of the departure of the locating hook 17 in front of the inner wall in section 6a, the pins 8 being inserted until they contact the stops 7. In this assembly phase the locating hooks 17 have passed the gradation 18 whereby they locate in the same. The dowel 13 is then inserted with the aid of a single pressure thrust as described for the preceding exemplary embodiment, wherein in this case however, the locating hooks 17 press against the front section 5a of the opening 4a, whereby a perfect connection of the two halves one with the other is achieved.

In this exemplary embodiment, in order to separate the two halves of the lye container a procedure equivalent to that of the preceding example is followed, whereby the dowel 13 is removed from the axial through hole 10 and then the locating hooks 17 are unlocked using a tool so that they release the gradation 18 whereby it is possible to remove the pin 8 from the interior of the opening 4 so that the two halves are separated.

For re-assembly of the drum, the same procedure as described for the preceding example is followed, namely the final joining using a self-tapping screw 19 and the corresponding washer 20.

1-11. (canceled)

12. A lye container for a washing machine, the lye container comprising two halves, which are provided with additional connecting means comprising pins (8) and an opening (4) at the mouths (1, 2) of their open base sections to produce a fixed connection of the two halves, the openings (4, 4a) are attached in radial extensions (3, 3a) of the mouth of one base section and have a rear section (5, 5a) in the plug direction of the pin (8) and a front connecting area (6, 6a) which has a smaller diameter (15, 18); and that the pins (8) of the mouth of the other base section have a diameter which is larger than the smaller diameter (15, 18) of the connecting area (6, 6a) of the openings (4, 4a) of the radial extensions (3, 3a), wherein the pins (8) have an axial through hole (10) which can be penetrated by a rear access with a dowel (13) of the same diameter as the through hole and that each pin (8) has longitudinal slots (9) on its front end for easier insertion of the pin (8) into the allocated opening (4, 4a), wherein the wall of the pin (8) in the connecting area (6, 6a) closes as the slot (9) becomes narrower, and for subsequent insertion of the dowel (13) into the axial through hole (10) of the pin (8), wherein the slots in the wall of the pin (8) open again and the walls of the pin (8) press towards the walls of the opening (4, 4a) of the radial extension (3, 3a).

13. The lye container according to claim 12, wherein the rear section (5) of the opening (4) of the radial extension (3) in the plug direction of the pin (8) has a diameter which increases from inside to outside.

14. The lye container according to claim 13, wherein the rear section (5) of the opening (4) of the radial extension (3) is constructed as truncated-cone-shaped.

15. The lye container according to claim 12, wherein the rear section (6) of the opening (4) of the radial extensions (3) has a diameter which increases from the outside to the inside to facilitate the insertion of the pin (8).

16. The lye container according to claim 15, wherein the front section (6) is constructed as truncated-cone-shaped.

17. The lye container according to claim 12, wherein in the transition region from the front section (6a) to the rear section (5a) of the opening (4a) a gradation (18) is provided at a larger diameter behind which locating hooks (17) which terminate the free end of the pin (8), engage.

18. The lye container according to claim 12, wherein the opening (4, 4a) comprises an insertion stop (7) for the pin (8).

19. The lye container according to claim 12, wherein the dowel (13) in the axial through hole (10) is held by means of fixing ribs (12) before its driving in the rear access of the axial opening (10).

20. The lye container according to claim 12, wherein the rear access of the axial opening (10) has an entry section (11) having a diameter larger than that of the dowel (13).

21. The lye container according to claim 12, wherein the radial extension (3, 3a) at the rear end of the pin (8) has a concentric protective projection (14) for the dowel (13).

22. The lye container according to claim 12, wherein a self-tapping screw (19) and a washer (20) are provided, that the self-tapping screw (19) is screwed into the axial through hole (10) of the pin (8) from the free end of the pin (8) to execute a safety connection wherein the washer (20) is arranged on the access of the opening (4) of the radial extensions (3).

23. A lye container for a washing machine, the lye container comprising:
a first container portion and a second container portion removably connected to one another, the first container portion having a first radial extension having a front section facing the second container portion and a rear section facing away from the second container portion;
an opening extending through the radial extension and having an inner diameter, the diameter near the rear section being greater than the diameter near the front section;
the second container portion having a second radial extension being removably engagable with the first radial extension, the engagement of the first and second radial extensions helping to create a seal between the first and second container portions;
a pin extending in an axial direction from the second radial extension to an outer end and having an outer diameter, an axial through hole, and longitudinal grooves extending along the pin, the maximum outer diameter of the pin being greater than the minimum inner diameter of the opening, the pin being at least partially disposed within the opening when the second radial extension engages the first radial extension; and
a dowel removably disposed within the axial through hole and helping maintain the second radial extension in engagement with the first radial extension.

24. The lye container according to claim 23, wherein the first radial extension includes stops extending inwardly near the rear section of the opening.

25. The lye container according to claim 23, wherein the dowel expands the outer end of the pin outwardly to engage the opening.

26. The lye container according to claim 23, wherein the opening near the rear section defines a truncated cone.

27. The lye container according to claim 23, wherein the axial through hole include fixing ribs to help retain the dowel in the desired position.

28. The lye container according to claim 23, wherein the first container portion includes multiple first radial extensions having openings and the second container portion includes multiple second radial extensions having pins, each pin being aligned with a corresponding opening.

29. The lye container according to claim 23, wherein the dowel includes a self-tapping screw.

30. The lye container according to claim 23, wherein the pin includes a hook near the outer end.
